(19) United States
(12) Patent Application Publication
(10) Pub. No.: US 2014/0182950 A1
(43) Pub. Date: Jul. 3, 2014

(54) HIDDEN WEIGHING DEVICE COUNTER

(71) Applicant: Yonatan Groman, Hogla (IL)

(72) Inventor: Yonatan Groman, Hogla (IL)

(21) Appl. No.: 13/729,036

(22) Filed: Dec. 28, 2012

(51) Int. Cl. G01G 19/42

(52) U.S. Cl. CPC G01G 19/42
USPC 177/1; 177/25.17

(57) ABSTRACT

A counter in which one or more weighing devices are discreetly embedded so that the buyer cannot see them, enabling efficient improvement of the work performance of salespeople with loading an accurate quantity of ice cream in a cup or cone, or of any other product in a suitable container, prior to being given to the buyer.

### FIELD OF THE INVENTION

The present invention relates to counters, more particularly to counters which include weighing devices that are embedded in the counters such that customers can't see them.

### BACKGROUND OF THE INVENTION

A common practice is to sell products, such as ice cream, with a counter separating the customer and the salesperson.

FIG. 1a of the prior art is an isometric schematic illustration of a counter 1.

Counter 1, shown in the present illustration, is particularly suitable for selling ice cream. It has a counter worker side 2w, next to which the salesperson works. Counter 1 usually also includes a freezer 14, disposed at its bottom part, containing ice-cream containers 13, while the top part can include a counter upper panel 11, upon which the salesperson can place products for the client, such as ice-cream cups 12, which the client can take.

The structure dividers of counter 1 are usually transparent, so that the client can see the products he wishes to buy, in the case shown in the present illustration, ice cream.

FIG. 1b of the prior art is another isometric schematic illustration of a counter 1.

Counter 1 has a counter client side 2c, next to which the client stands when he receives the product he is buying. During the sale of ice cream, the client commonly tells the salesperson which flavors he wishes to buy, and chooses between different portion sizes, such as small, medium, or large. In the next stage, the salesperson loads a cup or cone of ice cream as requested, while using a suitable mechanical tool, such as a scoop, and places the ice cream-laden cup or cone on the counter, from where the client collects it. This method of work is problematic, mainly because the less skilled the salesperson is, the less accurate the portion size loaded in the cup or cone may be, and this can be up to a deviation of ⅓ of the intended weight of a portion.

The client, even when unaware of portion weights, which can be for example respectively 140, 240, and 300 grams, can still notice and be disappointed if he receives a smaller portion than expected or than he is used to usually receive in the present place of purchase, or in other places. The business at which the sale is occurring could lose clientele as a result.

If the salesperson makes a mistake by loading too much ice cream, the profitability of the business is damaged.

There is therefore a need to provide the employees, particularly the salespeople, on the job with the skill to improve the precision with which they load portions of ice cream in cups or cones.

Even though the problem described in the present case occurs with regard to the sale of ice cream, this problem also occurs with the sale of other products.

### BRIEF SUMMARY EMBODIMENTS OF THE INVENTION

The background art does not teach or suggest a counter and work method enabling employees to improve their performance with regard to loading accurate portions of ice cream in cups or cones.

The present invention overcomes the deficiencies of the background art by providing hidden weighing device counters.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1a of the prior art is an isometric schematic illustration of a counter.

FIG. 1b of the prior art is another isometric schematic illustration of the counter.

FIG. 2 is a schematic illustration of a first exemplary embodiment of a hidden weighing device counter according to the present invention.

FIG. 3 is an exploded schematic illustration of an exemplary embodiment of a hidden weighing device assembly according to the present invention.

FIG. 4 is an exploded schematic illustration of a second exemplary embodiment of a hidden weighing device assembly according to the present invention.

FIG. 5 is an exploded schematic illustration of a third exemplary embodiment of a hidden weighing device assembly according to the present invention.

FIG. 6 is a schematic block diagram of the electrical system of a hidden weighing device counter according to the present invention.

FIG. 7 is a flow chart that schematically illustrates a method for improving the accuracy of preparing of a required weight of a product, such as an ice-cream in a cup, [symbol] that a salesperson is preparing for sale to a client, in accordance with an embodiment of the present invention, the method including the stages of:

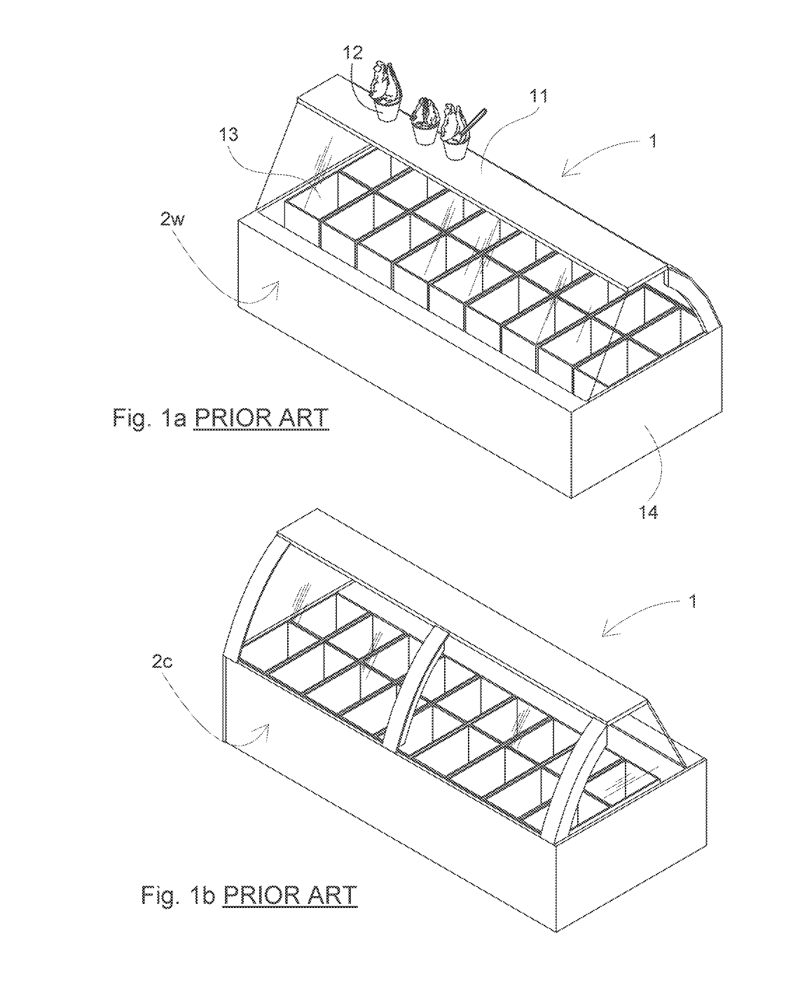

[symbol]

In order to leave no room for doubt, the elements shown in the illustrations of the present patent application in a manner that enables understanding them clearly, and the scales, size relations, and shapes are not in any way limiting their embodiment.

### DETAILED DESCRIPTION OF EMBODIMENTS OF THE INVENTION

To remove any doubt, note that the manner in which the elements of the present invention are described in the illustrations can be highly detailed, however is not in any way limiting the present invention, however is for the purpose of clarification and furthering understanding. The present invention can be implemented in embodiments that differ from the specification given with regard to the illustration.

The present invention is of a hidden weighing device counter.

The principles and operation of a hidden weighing device counter according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

A good method of improving the work performance of salespeople with loading an accurate quantity of ice cream in a cup or cone, or any other product in its designated container, is weighing the ice cream in the cup or cone before it is given to the client. However, this method has a major disadvantage, if the client sees the weighing device, which can be interpreted as miserliness and pettiness, thus harming the reputation of the business.

According to the present invention, one or more weighing devices are discreetly embedded within the sales counter, so that the customer cannot see or know that such a device is being used by the salesperson.

The weighing device can be mechanical with a display that the salesperson can see, or can be an electrical device. In the second case, an employee's sales data can be stored on a computer, or any other suitable means, and be used both for improving the employee's skill and also to enable the business owner or manager to track the performance of the salespeople.

According to the present invention, weighing device can also have a control panel into which the employee can enter his name or other identifying data at the beginning of a shift, and note the content and chosen quantity of ice cream portions with each loading. The data can be stored as noted.

The top part of each weighing device can be made of an identical or similar material and color to those of the sales counter, to achieve optimal camouflage.

According to another embodiment of the present invention, the weighing devices are embedded within an intermediate panel, disposed above the top part of the counter.

According to an additional embodiment of the present invention, a cover layer, composed of a single part or several parts, can be on top of each weighing device or perhaps even on top of the entire top part of the counter.

The following list is a legend of the numbering of the application illustrations:

1 prior art counter (such as ice-cream counter)

2 hidden weighing device counter (according to the present invention)

2c counter client side

2w counter worker side

11 counter upper panel

13 ice-cream container

14 freezer

20 hidden weighing device counter main assembly

30 hidden weighing device assembly

31 weighing device

31d weighing device width

31t weighing device thickness

31u weighing device upper side

32 keyboard

33 display panel

34 intermediate panel

34c intermediate panel client side

34d intermediate panel width

34n intermediate panel niche

34nb niche back wall

34ns niche side wall

34nt niche depth

34t intermediate panel thickness

34u intermediate panel upper side

34w intermediate panel worker side

36a main cover

36at main cover thickness

36au main cover upper side

36b secondary cover

36bt secondary cover thickness

36bu secondary cover upper side

40 computer

41 data base

50 electrical system

Hereinafter, embodiments of the present invention are explained in detail by referring to the drawings.

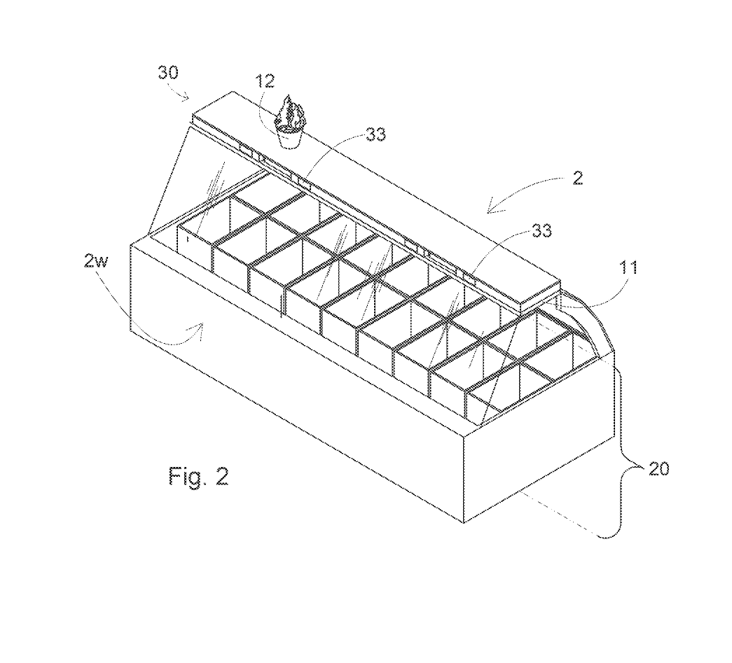

FIG. 2 is a schematic illustration of an exemplary embodiment of a hidden weighing device counter 2 according to the present invention.

The hidden weighing device counter 2 also includes a hidden weighing device counter main assembly 20 that can be identical or similar to any kind of prior art counter.

At the top part of the hidden weighing device counter 2, above a counter upper panel 11, if such an element exists, is located a hidden weighing device assembly 30.

Only someone standing on the counter worker side 2w can notice one or more display panels 33, which are located in the hidden weighing device assembly 30. The hidden weighing device assembly 30 can also bear items such as one or more ice-cream cups 12.

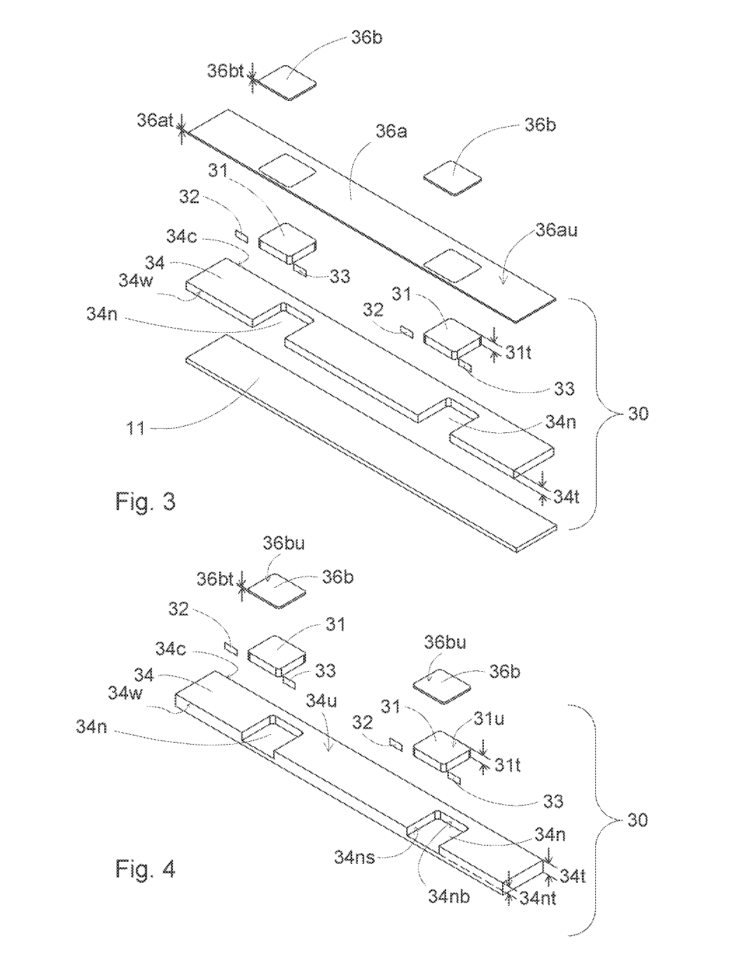

FIG. 3 is an exploded schematic illustration of a first exemplary embodiment of a hidden weighing device assembly 30 according to the present invention.

At the bottom part of the hidden weighing device assembly 30 is the counter upper panel 11, which is a component that is also common to hidden weighing device counter main assembly 20 (not shown in the present drawing, shown in FIG. 2).

The counter upper panel 11 can have a flat, rectangular shape made, as shown in the present illustration, of one continuous material, however this is in no way limiting the present invention. There may be other shapes, such as elliptical, arced, and many other suitable shapes which can apply for the purpose of a sales counter. The structure needn't even be continuous, and can rather be a net, bars, etc.

This clarification also applies to all other components of the hidden weighing device assembly 30.

Above the counter upper panel 11 are disposed one or more weighing devices 31, the maximum width dimension of which is weighing device thickness 31t. Furthermore, in the embodiment shown in the present illustration, above the counter upper panel 11 is an intermediate panel 34, which has an intermediate panel thickness dimension 34t, which is substantially equal to weighing device thickness 31t, in order to create an approximately flat plane between the upper surfaces of the weighing device 31 or devices and the intermediate panel 34.

The intermediate panel 34 has one or more intermediate panel niches 34n, having a shape and dimension suitable to contain a weighing device 31 within each one.

The intermediate panel 34 has also an intermediate panel client side 34c and an intermediate panel worker side 34w. The intermediate panel client side 34c shown in the present illustration has a structure designated to conceal the weighing device 31 (or devices) from sight of the client. The intermediate panel worker side 34w, on the other hand, can have a structure enabling the salesperson to see the weighing device 31 (or devices).

Furthermore, the hidden weighing device assembly 30 shown in the present illustration also includes one keyboard 32 and one display panel 33 for every weighing device 31, however other configurations are possible in the present invention.

The keyboard 32 and the display panel 33 are also disposed (and the structure of the hidden weighing device assembly 30 allows for this) so that they are not visible to the client, but are visible to the salesperson, who can operate them.

Above the weighing device 31 or devices and above the intermediate panel 34 there is located a main cover 36a, designated to conceal the weighing device 31 or devices underneath. Main cover 36a can have a uniform dimension of a main cover thickness 36at.

If the main cover 36a also covers a weighing device 31, it would be practical to design it of a non-rigid material, so as not to impair upon the precision of the weight measurement of anything placed on top. Each weighing device 31 can be separately covered with a secondary cover 36b.

Each secondary cover 36b can have a uniform dimension of secondary cover thickness 36bt, which according to the exemplary embodiment shown in the present illustration is substantially equal to main cover thickness 36at.

The main cover 36a has a main cover upper side 36au.

In any case, the cover of each weighing device 31 should be made of a non-transparent material, though other camouflage methods can also be used.

FIG. 4 is an exploded schematic illustration of a second exemplary embodiment of a hidden weighing device assembly 30 according to the present invention.

The structure of the hidden weighing device assembly 30 of the second exemplary embodiment resembles the structure of the hidden weighing device assembly 30 of the first exemplary embodiment shown in FIG. 3 however the counter upper panel (11) is presently included in the intermediate panel 34 and the hidden weighing device assembly 30 does not include a main cover 36a.

The intermediate panel niche 34n has a niche back wall 34nb and niche side walls 34ns.

Practically, the niche depth 34nt has an equal dimension to that of those of the weighing device thickness 31t and the secondary cover thickness 36bt combined.

This shows that there are various options to configure the hidden weighing device assembly 30, so that the weighing devices 31, the keyboards 32, and the display panels 33 cannot be seen by the buying client, however the salesperson will be able to acquire improved skill in loading accurate weights of ice cream in cups or cones, or of other products.

In any case, it is important that the color and texture of the upper sides of each component of the hidden weighing device assembly 30, such as the weighing device upper side 31u, the intermediate panel upper side 34u, the main cover upper side 36au, and the secondary cover upper side 36bu, resemble each other (namely those composing the top surface of the hidden weighing device assembly 30).

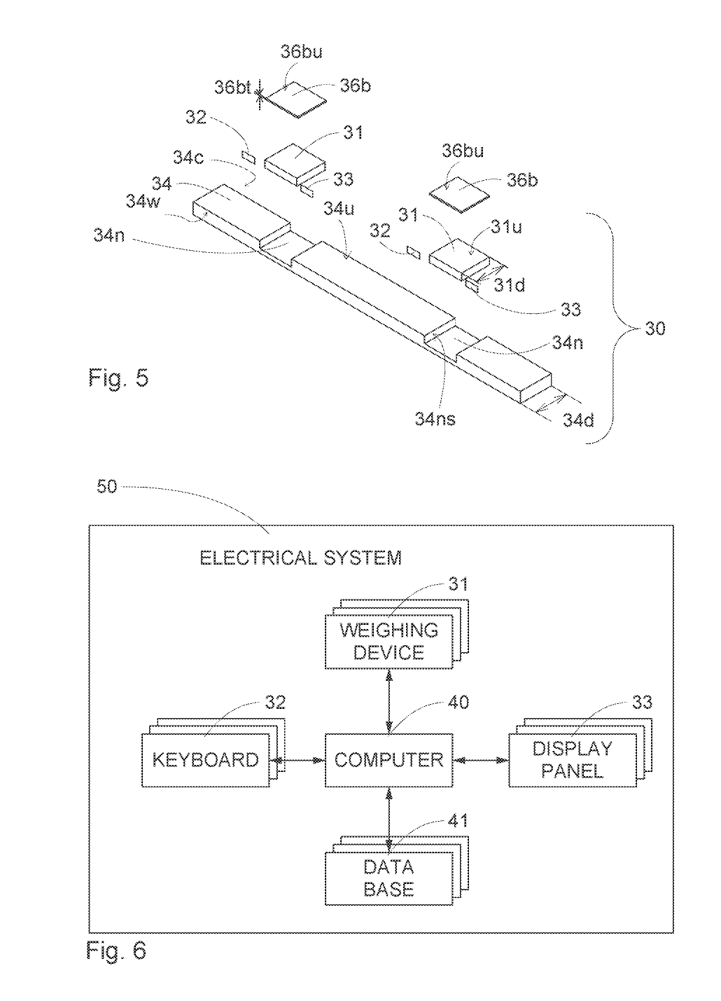

FIG. 5 is an exploded schematic illustration of a third exemplary embodiment of a hidden weighing device assembly 30 according to the present invention.

The third exemplary embodiment of a hidden weighing device assembly 30 resembles the second exemplary embodiment of a hidden weighing device assembly 30, and the description given for FIG. 4 also applies to the present illustration, except that the intermediate panel niche 34n covers the entire width of the intermediate panel 34, namely its dimension is that of the intermediate panel width 34d, and it has no niche back wall 34nb.

In this configuration, each weighing device 31 has a weighing device width 31d that also equals the intermediate panel width 34d.

In this configuration, when there are practically no gaps between the weighing devices 31 and the niche side wall 34ns of the intermediate panel niches 34n, from a top view, it is hard to tell the weighing devices 31 from the intermediate panel side 34s of the intermediate panel 34.

FIG. 6 is a schematic block diagram of the electrical system 50 of a hidden weighing device counter 2 according to the present invention.

The central component of the electrical system 50 of the hidden weighing counter 2 is a computer 40. For each weighing device 31 embedded in the hidden weighing device assembly 30, (not shown in the present drawing), the computer 40 receives input data from a keyboard 32 and a corresponding weighing device 31 and outputs data to the corresponding display panel 33.

Input data from a keyboard 32 can be the salesperson identification data (employee name, employee number etc.), currently served product details (portion size, flavor etc.), weight measurement command etc.

Once the salesperson places the product on the weighing device 31, the salesperson presses the keyboard 32 and sends the weight measurement command to the computer 40. The computer 40 then sends the weight measurement command to the weighing device 31 which in turn returns the measured weight of the product placed upon the weighing device 31. The computer 40 then sends the measured weight to the display panel 33 which displays the measured weight to the salesperson.

It is also possible to add a database 41 to the computer 40. The data base 41 can store weighing data for each salesperson over time for a manager to produce performance reports for each salesperson in order to evaluate and improve each salesperson's performance.

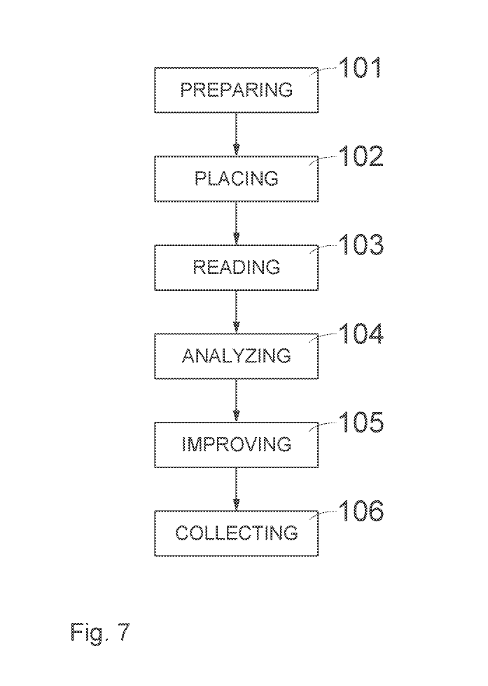

FIG. 7 is a flow chart that schematically illustrates a method for improving the accuracy of preparing of a required weight of a product, such as an ice-cream in a cup, that a worker is preparing for sale to a client, in accordance with an embodiment of the present invention, the method including the stages of:

preparing a product portion in a product cup (stage 101),

placing the product cup, loaded with the product portion, on a weighing device, wherein the weighing device is embedded within a counter, wherein the counter is configured to hide the weighing device from the client (stage 102),

reading the actual weight on the hidden weighing device by the salesperson (stage 103),

analyzing the error, which is the difference between the required weight to the actual weight (stage 104),

improving the accuracy of the required weight of another product portion, when preparing an additional product portion, based on the lesson that was learned from the previous preparation of the product portion (stage 105).

The method can also include:

collecting data regarding a salesperson accuracy performances of preparing of a required weight of a product (stage 106).

While the invention has been described with respect to a limited number of embodiments, it will be appreciated that many variations, modifications and other applications of the invention may be made.

What is claimed is:

1. A hidden weighing device counter comprising:
a hidden weighing device assembly, wherein said hidden weighing device assembly includes:
an intermediate panel, having at least one intermediate panel niche; and
at least one weighing device, wherein each one of said weighing device is located at another one of said intermediate panel niche, wherein said hidden weighing device assembly is configured to hidden said weighing devices from the eyes of a client.

2. The hidden weighing device counter of claim 1, wherein said intermediate panel has an intermediate panel thickness, wherein each one of said weighing devices has a weighing device thickness, wherein said intermediate panel thickness is practically equal to said weighing device thickness, and wherein each one of said intermediate panel niche has a niches back wall.

3. The hidden weighing device counter of claim 2, wherein said hidden weighing device assembly further includes:
a counter upper panel disposed on said intermediate panel.

4. The hidden weighing device counter of claim 2, wherein said hidden weighing device assembly further includes:
a main cover disposed on said intermediate panel.

5. The hidden weighing device counter of claim 2, wherein said hidden weighing device assembly further includes:
a counter upper panel disposed on said intermediate panel; and
a main cover disposed on said intermediate panel.

6. The hidden weighing device counter of claim 5, wherein said hidden weighing device assembly further includes:
at least one secondary cover, wherein each one of said secondary covers is disposed on one of said weighing devices.

7. The hidden weighing device counter of claim 6, wherein said main cover has a main cover thickness, wherein each one of said secondary cover has a secondary cover thickness, wherein said main cover thickness is practically equal to said secondary cover thickness.

8. The hidden weighing device counter of claim 1, wherein said intermediate panel includes a counter upper panel.

9. The hidden weighing device counter of claim 8 wherein said hidden weighing device assembly further includes:
at least one secondary cover having a secondary cover thickness, wherein each one of said weighing devices has a weighing device thickness, wherein said intermediate panel niche has a niche depth, wherein said niche depth is equal to the sum of said weighing device thickness and said secondary cover thickness.

10. The hidden weighing device counter of claim 9 wherein each one of said intermediate panel niches has a niche back wall.

11. The hidden weighing device counter of claim 9 wherein each one of said intermediate panel niches includes no niche back wall.

12. The hidden weighing device counter of claim 1, wherein said hidden weighing device assembly further includes:
at least one display panel operatively connected to another one of said weighing devices; and
at least one keyboard operatively connected to another one of said weighing devices.

13. The hidden weighing device counter of claim 12, wherein said hidden weighing device assembly further includes:
a computer, operatively connected to at least one of said weighing devices, one of said display panels, and one of said keyboards.

14. The hidden weighing device counter of claim 13, wherein said hidden weighing device assembly further includes:
a data base operatively connected to said computer.

15. The hidden weighing device counter of claim 1, further comprising:
a hidden weighing device counter main assembly, wherein said hidden weighing device assembly is disposed on said hidden weighing device counter main assembly.

16. A method for improving the accuracy of preparing of a required weight of a product, the method comprising:
preparing a product portion in a product cup;
placing said product cup, loaded with said product portion, on a weighing device, wherein said weighing device is embedded within a counter, wherein said counter is configured to hide said weighing device from a client;
reading an actual weight on said hidden weighing device by a salesperson;
analyzing an error, which is a difference between a required weight to an actual weight; and
improving said accuracy of said required weight of another product portion, when preparing an additional product portion, based on a lesson that was learned from a previous preparation of said product portion.

17. The method for improving the accuracy of preparing of a required weight of a product of claim 16 further comprising:
collecting data regarding a salesperson accuracy performances of preparing of a required weight of a product.
